(19) United States
(12) Patent Application Publication
(10) Pub. No.: US 2010/0081373 A1
(43) Pub. Date: Apr. 1, 2010

(54) SATELLITE FEED ASSEMBLY WITH INTEGRATED FILTERS AND TEST COUPLERS

(75) Inventors: Sudhakar K. RAO, Churchville, PA (US); Surjit S. Dhillon, Robbinsville, NJ (US); Clency Lee-Yow, Niwot, CO (US); Jonathan Raymond Scupin, Longmont, CO (US)

Correspondence Address: MCDERMOTT WILL & EMERY LLP, 18191 VON KARMAN AVE., SUITE 500, IRVINE, CA, 92612-7108, US

(73) Assignee: LOCKHEED MARTIN CORPORATION, Bethesda, MD (US)

(21) Appl. No.: 12/243,832

(22) Filed: Oct. 1, 2008

(51) Int. Cl. H04B 7/185

(52) U.S. Cl. 455/12.1

(57) ABSTRACT

A dual-band feed assembly is configured to be coupled to a satellite repeater payload. The dual-band feed assembly includes a transmit filter assembly comprising a transmit pass-band filter configured to reject frequencies outside of a transmit frequency band and a low-pass and harmonic filter configured to reject receive band frequencies and harmonics of the transmit frequency band. The dual-band feed assembly further includes a receive filter assembly comprising a receive pass-band filter configured to reject frequencies outside of a receive frequency band and a high-pass filter configured to reject transmit band frequencies. A multi-port junction couples the transmit and receive waveguide assemblies to a dual-band horn. The dual-band feed assembly also may include receive and transmit test couplers.

### STATEMENT REGARDING FEDERALLY SPONSORED RESEARCH OR DEVELOPMENT

Not applicable.

### FIELD OF THE INVENTION

The invention relates to satellite payloads and, in particular, is directed to a satellite feed assembly with integrated filters and test couplers.

### BACKGROUND OF THE INVENTION

Satellites have greatly expanded the communication capabilities available for a number of different applications. Communications satellites facilitate the transmission of voice and data over long distances. Direct broadcast satellites provide video and audio content distribution to geographical areas that greatly exceed those serviceable by conventional terrestrial distribution systems. Broadband satellites provide personal communications including data transfer among users located within a geographical region. The demand for satellites having larger capacities (e.g., 100 Gbps) to improve the broadband services is constantly increasing.

Broadband communication satellites typically are configured to use multiple beams providing forward and return communication links. In the forward link, a gateway on the ground transmits signals to a satellite. The satellite receives the signals in a receive band, down-converts the signals to a transmit band, amplifies the transmit signals using amplifiers such as traveling wave tube amplifiers (TWTAs), and transmits the amplified signals to user beams on the ground. Similarly, in the return link, a user on the ground transmits signals to the satellite. The satellite receives the signals in a receive band, down-converts the signals to a transmit band, amplifies the transmit signals using amplifiers such as TWTAs, and transmits the amplified signals to gateway beams. Forward and return communication links use separate frequencies and/or orthogonal polarizations to minimize interference between the links.

Satellite capacity can be increased by providing more user beams and gateway beams for communication links. However, the hardware required to support each beam effectively limits the number of beams a single satellite can provide. For example, the repeater payload of a communication satellite typically includes filter assemblies and test couplers in the transmit and receive signal paths of each beam. Limitations on the size and weight of the repeater payload constrain the amount of hardware that can be accommodated on the spacecraft bus and therefore the number of beams that a given satellite can support. Often times these limitations are reached well before the capacity demands of modern communication applications are met.

Accordingly, a need exists for new satellite configurations that increase communications capacity within the limitations imposed by payload size, weight and accommodation constraints.

### SUMMARY OF THE INVENTION

The invention provides an improved satellite feed assembly that reduces the amount of hardware required to support each beam of a multi-beam payload. This hardware reduction is accomplished by removing filter assemblies from the satellite repeater payload and integrating filter functionality into the feed assembly itself. Additionally, test couplers also can be removed from the satellite repeater payload and integrated with the feed assembly. This high level integration at the feed level minimizes the number of RF interfaces and waveguide lengths, resulting in reduced losses and hardware reduction. The cost and weight savings achieved by removing filter assemblies and test couplers from the satellite repeater payload allow hardware for additional beams to be added to the payload, thereby increasing the communications capacity of the satellite.

According to one embodiment, a dual-band feed assembly is configured to be coupled to a satellite repeater payload. The dual-band feed assembly includes a transmit filter assembly comprising a transmit pass-band filter configured to reject frequencies close to and outside a pass-band of a transmit frequency band and a low-pass and harmonic filter configured to reject receive frequencies and harmonics of the transmit frequency band. The dual-band feed assembly further includes a receive filter assembly comprising a receive pass-band filter configured to reject frequencies close to and outside a pass-band of a receive frequency band and a high-pass filter configured to reject transmit frequencies. A multi-port junction couples the transmit and receive waveguide assemblies to a dual-band horn. The dual-band feed assembly may include integrated transmit and receive test couplers and orthogonal waveguide ports to support orthogonal polarizations (e.g., left hand circular polarization (LHCP) and right hand circular polarization (RHCP)) for both the transmit and receive bands.

The foregoing summary of the invention has been provided so that the nature of the invention can be understood quickly. A more detailed and complete understanding of the preferred embodiments of the invention can be obtained by reference to the following description of the invention together with the associated drawings.

### BRIEF DESCRIPTION OF THE DRAWINGS

FIG. 1 is a block diagram depicting communication components of a satellite according to one embodiment.

FIG. 2 is a schematic diagram depicting a dual-band feed assembly according to one embodiment of the invention.

FIG. 3 is a schematic diagram depicting a cutaway view of low-pass filter combined with a harmonic filter according to one embodiment of the invention.

FIG. 4 is a schematic diagram depicting a cutaway view of a transmit band pass filter according to one embodiment of the invention.

FIG. 5 is a schematic diagram depicting a cutaway view of a receive band pass filter according to one embodiment of the invention.

FIG. 6 is a schematic diagram depicting a dual-band feed assembly with integrated filters and test couplers according to one embodiment of the invention.

FIG. 7 is a graph depicting the frequency response and return loss of an input filter assembly according to one embodiment of the invention.

FIG. 8 is a graph depicting the frequency response and return loss of an input filter assembly according to one embodiment of the invention.

FIG. 9 is a graph depicting the frequency response and return loss of an input filter assembly according to one embodiment of the invention.

FIG. 10 is a graph depicting the frequency response and return loss of an output filter assembly according to one embodiment of the invention.

FIG. 11 is a graph depicting the frequency response and return loss of an output filter assembly according to one embodiment of the invention.

FIG. 12 is a graph depicting the frequency response and return loss of an output filter assembly according to one embodiment of the invention.

FIG. 13 is a graph depicting the frequency response and return loss of an output filter assembly according to one embodiment of the invention.

### DESCRIPTION OF THE INVENTION

The detailed description of the invention set forth below in connection with the associated drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without all of the specific details contained herein. In some instances, well known structures and components are shown in block diagram form in order to avoid obscuring the concepts of the invention.

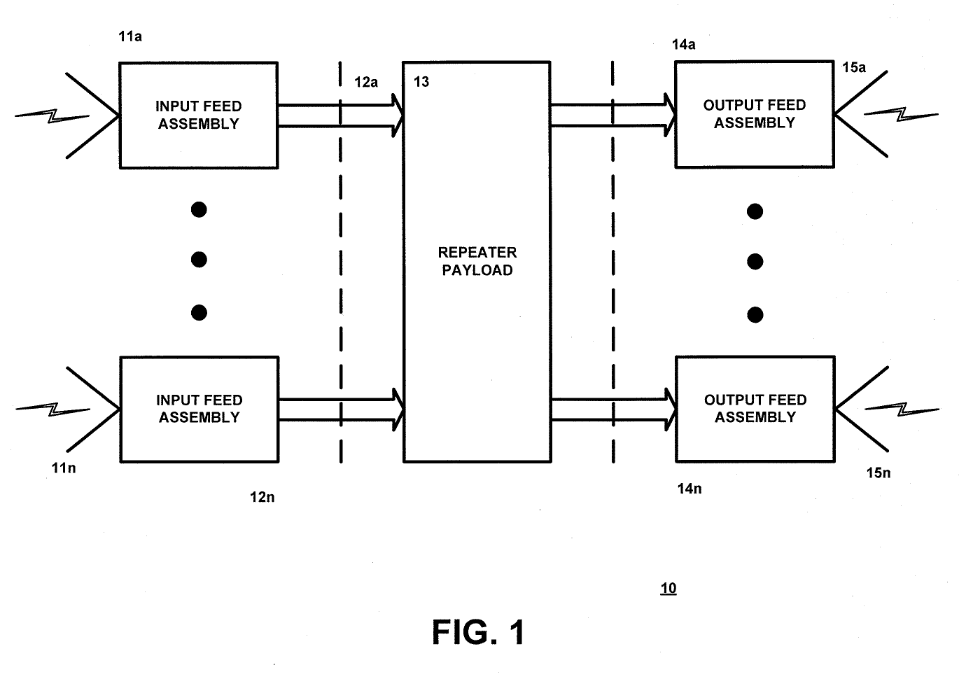

FIG. 1 is a block diagram depicting communication components of a satellite 10 that will be used to describe various aspects of the invention. Satellite 10 includes input horns 11a-11n, input feed assemblies 12a-12n, repeater payload 13, output feed assemblies 14a-14n and output horns 15a-15n. Briefly, input feed assemblies 12a-12n receive one or more signals via respective horns 11a-11n. The signals are fed to repeater payload 13 through waveguides represented by the arrows depicted in FIG. 1 coupling input feed assemblies 12a-12n to repeater payload 13. Within repeater payload 13, the signals are down-converted to the transmit band and amplified using high-power amplifiers. The amplified signals are then fed to one or more output feed assemblies 14a-14n through waveguides represented by the arrows coupling repeater payload 13 to output feed assemblies 14a-14n. The signals then are transmitted via respective output horns 15a-15n.

In more detail, a first station (e.g., user, gateway) transmits a signal to satellite 10. The signal is a radio frequency signal within a receive frequency band, such as the Ka band (28-30 GHz). The signal is captured by one or more input horns 11a-11n and focused into respective ones of input feed assemblies 12a-12n, which supply the signal to repeater payload 13. The number of input horns 11 and input feed assemblies 12 receiving the signal will depend on the number of beams of the satellite covering the location of the first station, where each input horn 11 and coupled input feed assembly 12 provides a single receive beam.

Repeater payload 13 down-converts the received signal to a transmit band and prepares it for transmission within a transmit frequency band via one or more output feed assemblies 14a-14n and respective output horns 15a-15n. Processing the signal typically includes amplifying the received signal, removing the signal from a first carrier frequency on which it was received, and placing it on a second carrier frequency within a transmit frequency band such as the K band (18.0-22.0 GHz) and amplifying the transmit signal using high-power TWTAs in order to meet effective isotropic radiated power (EIRP) requirements. Processing the signal also may include routing and/or distributing the received signal among the output feed assemblies. For example, a signal received via one input feed assembly 12 may be routed to a single output feed assembly 14. Alternatively, repeater payload 13 may make a determination based on the contents of the signal as to which output feed assemblies 14a-14n is to be used to transmit the signal to one or more second stations (e.g., user, gateway) located within the beams corresponding to respective output feed assemblies 14 and coupled output horns 15. The signal may be transmitted via one output feed assembly 14 or via multiple output feed assemblies 14.

Output feed assemblies 14a-14n receive one or more signals from repeater payload 13 and feed the signals to respective output horns 15a-15n. In this manner, the one or more signals are transmitted to the second station(s) located within the beams corresponding to the respective output horns 15a-15n.

Prior to being amplified and routed within repeater payload 13, the received signals must be filtered to reject frequencies outside of the receive frequency band. Similarly, the signals amplified and routed by repeater payload 13 must be filtered to reject frequencies outside of the transmit frequency band prior to transmission. As noted above, the invention removes the input/output filter assemblies that conventionally are located within repeater payload 13 in order to reduce the size and weight of the satellite repeater payload and to allow additional hardware to be included in the satellite repeater payload to support additional beams for increased communications capacity. The input/output filtering used to process the signals is integrated into the input/output feed assemblies, as described in more detail below. The dashed lines shown in FIG. 1 represent the interface between the satellite repeater payload, which includes repeater payload 13, and the input/output feed assemblies 12 and 14.

The invention is not limited to any particular number of input feed assemblies 12, with respective coupled input horns 11. Similarly, the invention is not limited to any particular number of output feed assemblies 14, with respective coupled output horns 15. Those skilled in the art will recognize that the number of feed assemblies will vary depending on the intended application and the size and weight limitations of the satellite repeater payload. Those skilled in the art will further recognize that input feed assemblies 12 may share a dual-band horn with respective output feed assemblies 14. For example, input feed assembly 12a and output feed assembly 14a may share a common dual-band horn thereby forming a single integrated dual-band feed assembly. In this manner, both forward and return communication links are implemented within a single beam, which increases the communications capacity of the satellite.

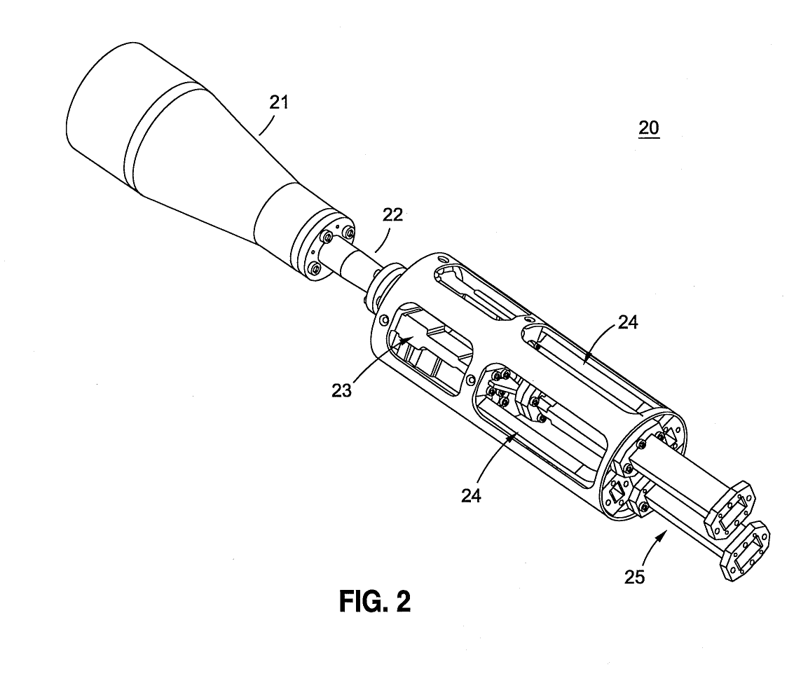

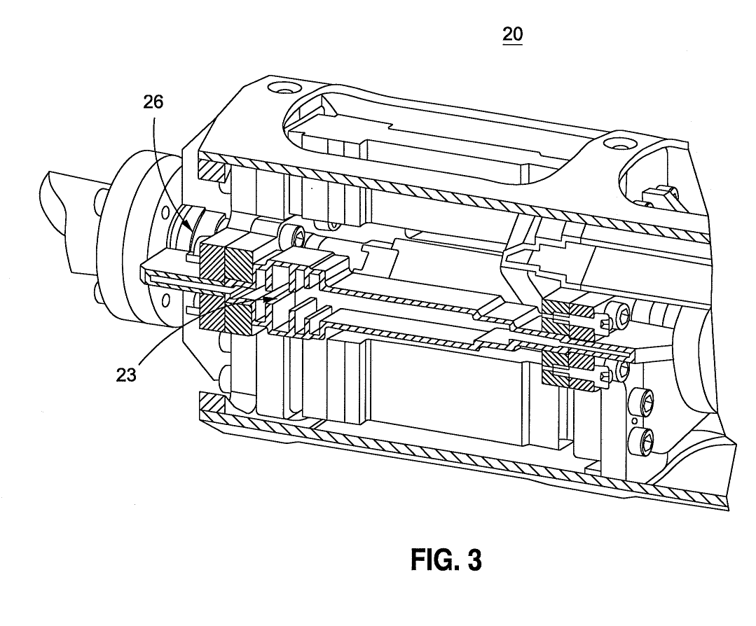

FIG. 2 is a schematic diagram depicting a dual-band feed assembly 20 according to one embodiment. As depicted in FIG. 2, dual-band feed assembly 20 includes dual-band horn 21, multi-port junction 22, low-pass and harmonic filters 23, receive band pass filters 24 and transmit band pass filters 25. Low-pass and harmonic filters 23 and transmit band pass filters 25 comprise a transmit (output) filter assembly. Receive band pass filters 24 and cut-off waveguide 26 (shown in FIG. 3) comprise a receive (input) filter assembly.

According to one embodiment, dual-band horn 21 is a high efficiency horn configured to receive signals within a receive frequency band and transmit signals within a transmit frequency band. The invention is not limited to any particular type of horn so long as the horn supports both of the transmit and receive frequency bands. Multi-port junction 22 separates the transmit and receive signals from the dual-band horn 21 and propagates them via the receive filter assembly and the transmit filter assembly to and from the repeater payload. The multi-port junction 22 provides dual-orthogonal polarizations (e.g., RHCP and LHCP) for each of the transmit and receive signals.

The transmit filter assembly includes low-pass and harmonic filter 23. Low-pass and harmonic filter 23 is configured to reject the receive frequencies and the harmonics of the transmit frequency band to prevent receive signals and transmission of the harmonic signals within the beam. In the embodiment depicted in FIG. 2, four low-pass and harmonic filters 23 are coupled to multi-port junction 22. Alternative embodiments of the invention may include more or less than four harmonic filters 23.

FIG. 3 depicts a cutaway view of low-pass and harmonic filter 23 within feed assembly 20 according to one embodiment. As shown in FIG. 3, low-pass and harmonic filter 23 comprises a number of corrugations arranged in the transmission path to reject the receive frequencies and the harmonics of the transmit frequency band frequencies. According to one embodiment, harmonic filtering is integrated with the receive filtering by increasing the number of corrugations in filter 23. This single component within feed assembly 20 provides both low-pass filtering and harmonic filtering within the transmission signal path. The dimensions and arrangement of the corrugations within the filter depend on the transmit frequency band and the desired filter parameters. Filter design based on the foregoing description is within the knowledge of those skilled in the art and will not be discussed in further detail herein. Those skilled in the art will further recognize that other filter constructions may be used to implement low-pass and harmonic filter 23 without departing from the scope of the invention. For example, low-pass and harmonic filter 23 may be implemented using a plurality of irises or stubs within sections of a waveguide.

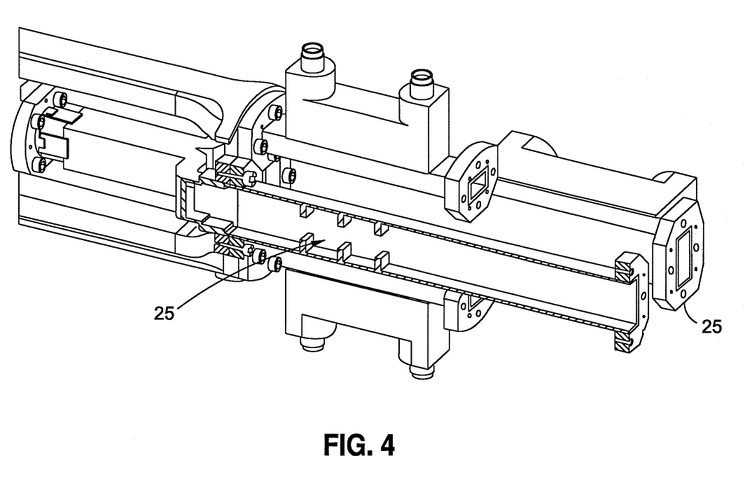

The transmit filter assembly further includes transmit band pass filter 25. Transmit band pass filter 25 is configured to reject frequencies close to the transmit band and outside the transmit pass band. In the embodiment depicted in FIG. 2, two transmit band pass filters 25 are arranged within feed assembly 20. One transmit band pass filter 25 is configured for a transmit signal having a right-hand polarization; the other transmit band pass filter 25 is configured for a transmit signal having a left-hand polarization. FIG. 4 depicts a cutaway view of transmit band pass filter 25. As shown in FIG. 4, transmit band pass filter 25 may be implemented by adding irises to a transmit waveguide section. The dimensions and arrangement of the irises within the filter depend on the transmit frequency band and the desired rejection outside the transmit pass-band. Filter design based on the foregoing description is within the knowledge of those skilled in the art and will not be discussed in further detail herein. Those skilled in the art will further recognize that other filter constructions may be used to implement transmit band pass filter 25 without departing from the scope of the invention. For example, transmit band pass filter 25 may be implemented as a six-pole filter.

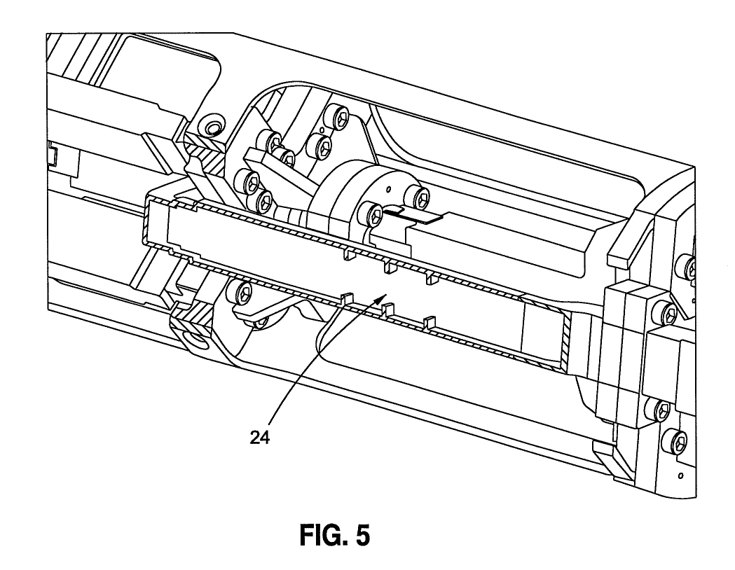

The receive filter assembly includes receive band pass filter 24. Receive band pass filter 24 is configured to reject frequencies close to the receive band and outside of the receive pass band, including the frequencies of radio astronomy bands. In the embodiment depicted in FIG. 2, two receive band pass filters 24 are arranged within feed assembly 20. One receive band pass filter 24 is configured for a receive signal having a right-hand polarization; the other receive band pass filter 24 is configured for a receive signal having a left-hand polarization. FIG. 5 depicts a cutaway view of receive band pass filter 24. As shown in FIG. 5, receive band pass filter 24 may be implemented by adding irises to a waveguide within assembly 20. The dimensions and arrangement of the irises within the filter depend on the receive frequency band and the desired rejection outside the receive pass-band. Filter design based on the foregoing description is within the knowledge of those skilled in the art and will not be discussed in further detail herein. Those skilled in the art will further recognize that other filter constructions may be used to implement receive band pass filter 24 without departing from the scope of the invention. For example, receive band pass filter 24 may be implemented using a cut-off waveguide section.

In addition, the transmit signals are rejected using cut-off waveguide 26 arranged just after the multi-port junction 22 away from horn 21. Furthermore, two separate septum polarizers are used to generate dual-circular polarizations for the receive and transmit signals.

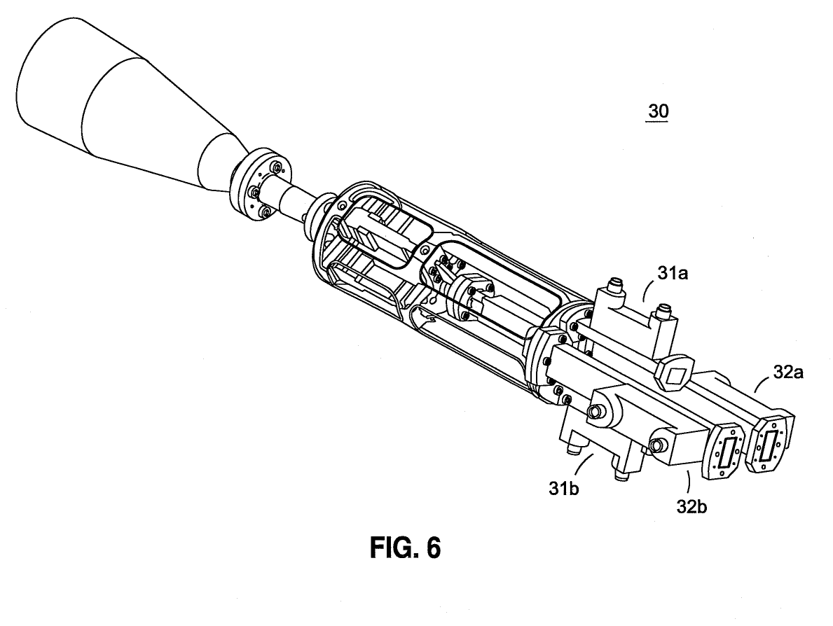

Turning to FIG. 6, a schematic diagram depicting a dual-band feed assembly 30 according to one embodiment of the invention is shown. The primary difference between dual-band feed assembly 20 represented in FIG. 2 and dual-band feed assembly 30 represented in FIG. 3 is the integration of test couplers 31a and 31b and 32a and 32b with dual-band feed assembly 30. According to one embodiment, test couplers 31a and 31b are compact broad-wall couplers for testing the two receive signal paths (e.g., RHCP and LHCP) within the receive filter assembly. Similarly, test couplers 32a and 32b are compact broad-wall couplers for testing the two transmit signal paths (e.g., RHCP and LHCP) within the transmit filter assembly. The test couplers may be bi-directional and are used for monitoring and testing forward power and return power of channels transmitted via dual-band feed assembly 30 during the payload tests of a spacecraft and are terminated with loads prior to launch of the spacecraft.

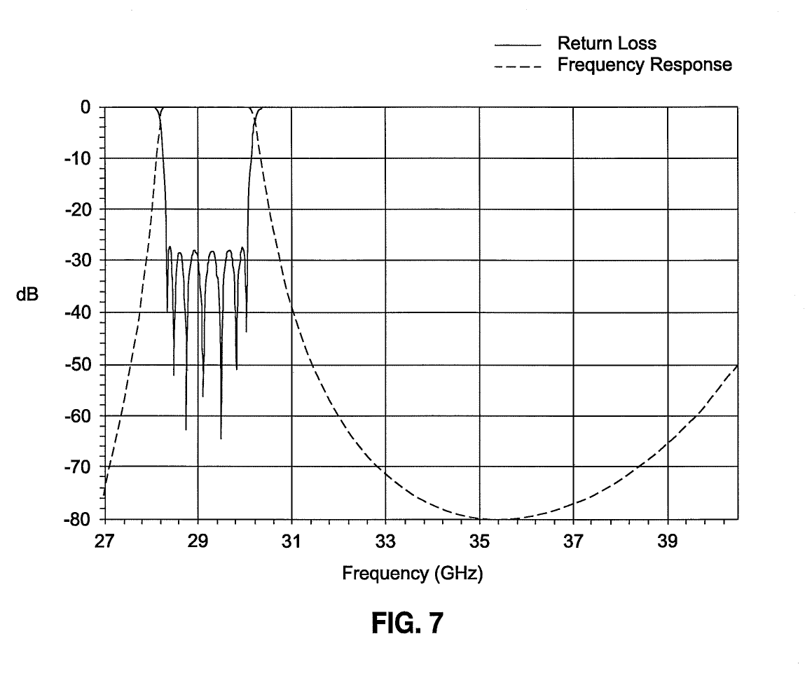

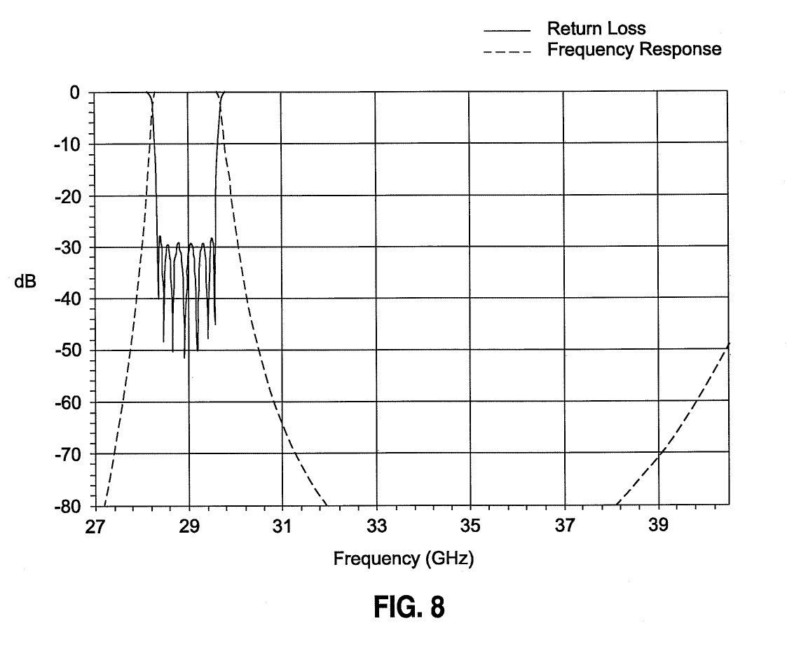

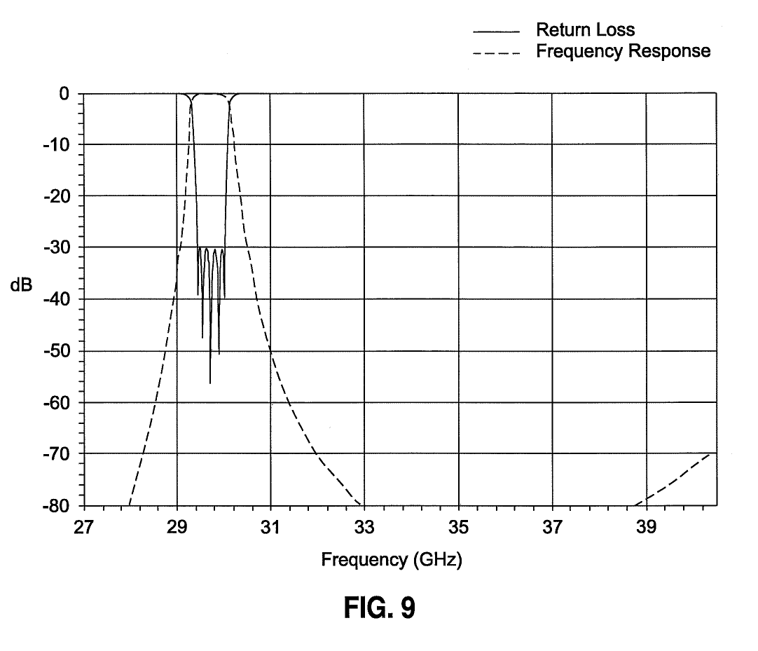

The performance of the input filter assembly incorporated within a satellite feed assembly according to one embodiment of the invention is demonstrated in the graphs depicted in FIGS. 7 to 9. FIG. 7 depicts the frequency response and return loss of the input filter assembly for the frequency pass band from 28.35 GHz to 30.00 GHz. FIG. 8 depicts the frequency response and return loss of the input filter assembly for the frequency pass band from 28.35 GHz to 29.50 GHz. FIG. 9 depicts the frequency response and return loss of the input filter assembly for the frequency pass band from 29.50 GHz to 30.00 GHz. As represented in each of FIGS. 7, 8 and 9, the input filter assembly integrated within a satellite feed assembly according to one embodiment provides frequency rejection close to the pass band as well as rejection of greater than 50 dB at radio astronomy bands.

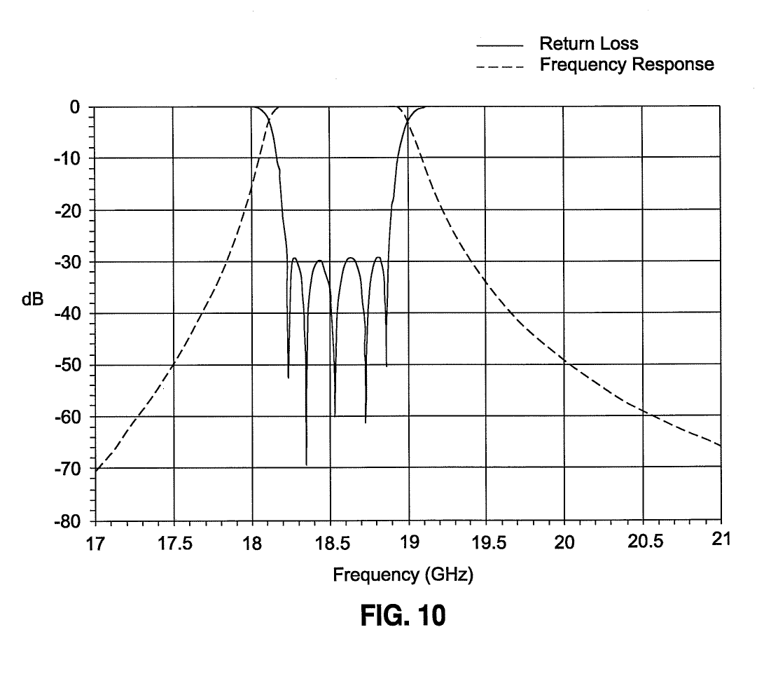

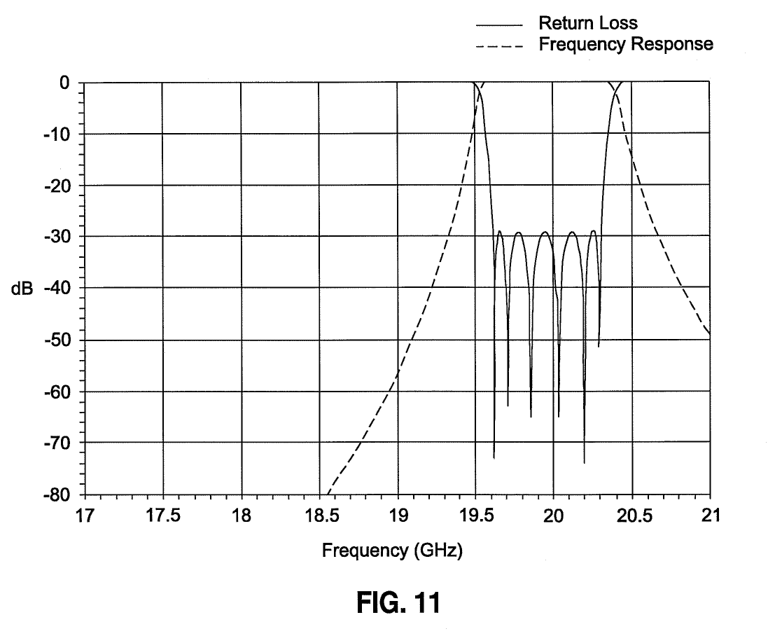

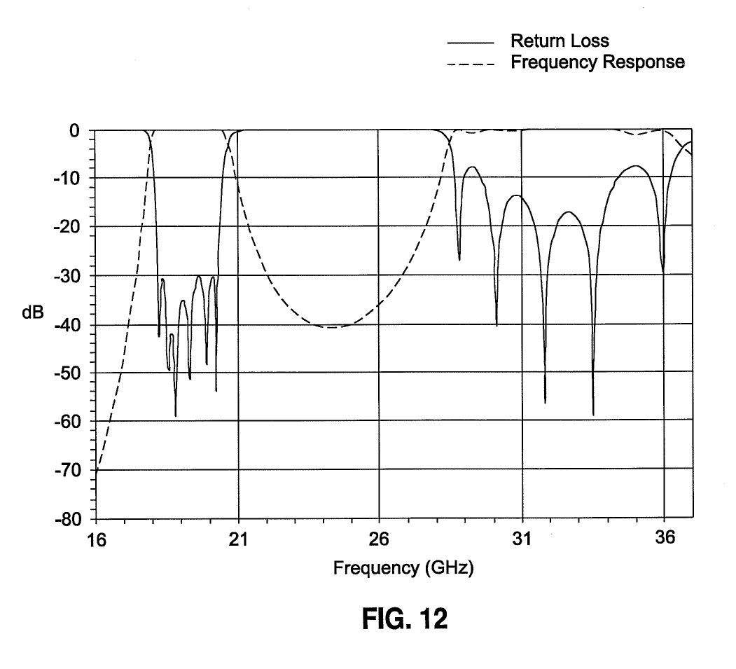

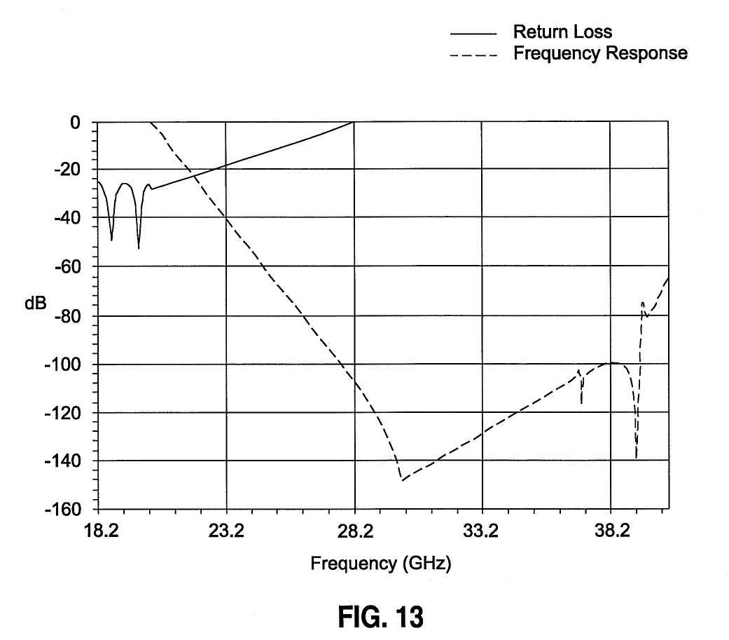

The performance of the output filter assembly incorporated within a satellite feed assembly according to one embodiment of the invention is demonstrated in the graphs depicted in FIGS. 10, 11, 12 and 13. FIG. 10 depicts the frequency response and return loss of the output filter assembly for the frequency pass band from 18.3 GHz to 18.8 GHz. FIG. 11 depicts the frequency response and return loss of the output filter assembly for the frequency pass band from 19.7 GHz to 20.2 GHz. FIG. 12 depicts the frequency response and return loss of the transmit band pass filter of the output filter assembly for the frequency band from 18.3 GHz to 20.2 GHz. FIG. 13 depicts the frequency response and return loss of the complete output filter assembly for the frequency band from 18.3 GHz to 20.2 GHz. Each of FIGS. 10 to 13 show near in band rejection of the output filter assembly integrated within a satellite feed assembly according to one embodiment of the invention. FIG. 13 further demonstrates the ability of the harmonic transmit filter to provide rejection at radio astronomy bands.

The removal of the filter assemblies from the repeater payload and the integration of the filter functionality into the satellite feed assembly provides significant benefits over conventional satellite feed assemblies. For example, costs are reduced due to the reduced hardware requirements. The reduced hardware requirements translate further into a reduction of overall mass of the satellite and the size of the payload. In addition, the removal of filter assemblies from the repeater payload reduces the waveguide lengths signals must travel as well as the number of interfaces within the signal paths. This shortening of the waveguide lengths and removal of interfaces within the signal paths reduces insertion losses and improves payload performance.

In one representative example, a satellite feed assembly configured according to the embodiment depicted in FIG. 6 provided significant advantages in both weight and cost. For example, a conventionally arranged satellite feed assembly and repeater payload having 85 feed horn assemblies and 98 sets of input filter assemblies and output filter assemblies had a total mass of 72,214 grams and a total cost of $11,809,000. Using a satellite feed assembly configured as described above, reduced the total weight required to implement the feed horn assemblies and the input and output filter assemblies to 50,830 grams and a total cost of $5,780,000. This reduction of 21.38 Kgs and $6.03 million demonstrates a significant advantage to satellite design afforded by the present invention.

In addition to cost and weight improvements, the present invention provides improvement to the overall performance of the satellite feed assembly and input/output filter assemblies. By integrating the input and output filter assemblies into the satellite feed assembly, the total waveguide length and the number of waveguide junctions traveled by transmit and receive signals is reduced. This has resulted in approximately 0.4 dB improvement in RF performance, which translates into about 10% improvement in both EIRP and G/T in RF performance.

The foregoing description is provided to enable one skilled in the art to practice the various embodiments of the invention described herein. Various modifications to these embodiments will be readily apparent to those skilled in the art, and generic principles defined herein may be applied to other embodiments. Thus, the following claims are not intended to be limited to the embodiments of the invention shown and described herein, but are to be accorded the full scope consistent with the language of the claims. All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A dual-band feed assembly configured to be coupled to a satellite repeater payload, comprising:
a transmit filter assembly comprising a transmit pass-band filter configured to reject frequencies outside a pass-band of a transmit frequency band and a low-pass and harmonic filter configured to reject receive band frequencies and harmonics of the transmit frequency band;
a receive filter assembly comprising a receive pass-band filter configured to reject frequencies outside of a receive frequency band and a high-pass filter configured to reject transmit band frequencies;
a dual-band horn configured to transmit and receive signals; and
a multi-port junction coupling said transmit and receive filter assemblies to said dual-band horn.

2. The dual-band feed assembly according to claim 1, further comprising:
a first polarizer configured to provide dual circular polarizations to transmit signals; and
a second polarizer configured to provide dual circular polarizations to receive signals.

3. The dual-band feed assembly according to claim 1, wherein said transmit filter assembly further comprises a transmit bidirectional test coupler.

4. The dual-band feed assembly according to claim 1, wherein said receive filter assembly further comprises a receive bidirectional test coupler.

5. The dual-band feed assembly according to claim 1, wherein said transmit pass-band filter is an iris filter.

6. The dual-band feed assembly according to claim 1, wherein said low-pass and harmonic filter is a corrugated filter.

7. The dual-band feed assembly according to claim 3, wherein said receive pass-band filter comprises a plurality of waveguide sections separated by a plurality of irises.

8. The dual-band feed assembly according to claim 1, wherein said high-pass filter comprises a cut-off waveguide section configured to reject transmit signals.

9. A satellite, comprising:
a plurality of the dual-band feed assemblies according to claim 1 configured to transmit and receive signals; and
a repeater payload coupled to said plurality of dual-band feed assemblies and configured to process the transmitted and received signals.
